(19) United States
(12) Patent Application Publication
(10) Pub. No.: US 2006/0190600 A1
(43) Pub. Date: Aug. 24, 2006

(54) Group based presence availability management

(75) Inventors: Jeffrey Mark Blohm, Menlo Park, CA (US); Peter Jan Kozdon, Santa Clara, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/060,844

(22) Filed: Feb. 18, 2005

(51) Int. Cl. G06F 15/173

(52) U.S. Cl. 709/225

(57) ABSTRACT

A presence management system allows or blocks access to presence information at a group-level. A subscriber assigns contacts to groups and sets presence access parameters for the groups. In response to a request for the presence information, the presence management system determines a contact group assigned to the requester and checks the group access parameter. Access is allowed or blocked based on the group access parameter and based on overriding access parameters that may be established in the presence management system.

### FIELD OF THE INVENTION

This invention relates to presence and presence management systems that communicate presence information. In particular, this invention relates to a presence system that manages the availability of presence information in a group driven manner.

### BACKGROUND OF THE INVENTION

Rapid developments in communication technology, driven by strong market demand, have led to sophisticated presence systems. Presence information maintained in the presence system may indicate when a subscriber is on the phone, at his desk, in a meeting, or in other presence states. This presence information may be shared with other subscribers if the presence system permits access to the presence information.

In order to control access, the subscriber manually configures individual contacts to permit or deny access to the subscriber's presence information. Contacts, or contacts matching a pattern, that have been permitted access are allowed to receive the subscriber's presence information. Otherwise, the presence system blocks access to the subscribers presence information.

There are significant disadvantages with this approach. For example, the subscriber is required to laboriously manage access to their presence information on a contact-by-contact basis. Furthermore, automatically adjusting access to the presence information would be extremely cumbersome on a subscriber-by-subscriber basis.

A need has long existed for improved management of the availability of presence information.

### SUMMARY

A presence system manages the availability of subscriber presence information sought by a requestor. In response to a request for the presence information, the presence system determines a contact group assigned to the requestor by the system subscriber. The presence system also checks a group access parameter associated with the contact group. The group access parameter may determine whether contact group members, such as the requestor, are allowed access or are denied access to the requested presence information.

When access is allowed, the presence system may further manage the presence information delivered to the requestor. To that end, the presence system determines an allowed portion and/or a blocked portion of the requested presence information. The allowed portion of the presence information is delivered to the requestor, and the denied portion is withheld from the requestor.

The presence system may include a memory and a processor. The memory stores a contact for the presence requestor and a contact group to which the contact is assigned. A group access parameter in the memory is associated with the contact group. The group access parameter may specify whether group members are allowed access or are denied access to requested presence information.

An access determination program checks the group access parameter to determine whether the group members are allowed access to the requested presence information. When the group members are allowed access, the presence system may respond to the requestor with the subscriber presence information. The processor executes the access determination program.

The present invention is defined by the following claims, and nothing in this section should be taken as a limitation on those claims. Further aspects and advantages of the invention are discussed below in conjunction with the preferred embodiments. Any one or more of the above described aspects or aspects described below may be used independently or in combination with other aspects described herein.

### BRIEF DESCRIPTION OF THE DRAWINGS

FIG. 1 illustrates one implementation of a presence network.

FIG. 2 illustrates one implementation of a presence responder.

FIG. 3 illustrates a distinction between groups that are configured by the system subscriber to allow or block access to presence information for contacts in the groups.

FIG. 4 illustrates a distinction between groups that are configured by the system subscriber and mandatory policies to allow or block access to presence information for contacts in the groups.

FIG. 5 illustrates contact groups arranged with respect to override access parameters and subscriber adjustable access parameters.

FIG. 6 illustrates a distinction between portions of presence information that are available to a requestor and portions of presence information that are blocked from the requester.

FIG. 7 illustrates the acts that the presence system may take to determine whether to provide presence information to a requestor.

FIG. 8 illustrates the acts that the presence system may take to automate allowing or blocking access to presence information.

### DETAILED DESCRIPTION

The elements illustrated in the Figures interoperate as explained in more detail below. Before setting forth the detailed explanation, however, it is noted that all of the discussion below, regardless of the particular implementation being described, is exemplary in nature, rather than limiting. For example, although selected aspects, features, or components of the implementations are depicted as being stored in hardware memories, all or part of systems and methods consistent with the presence systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the presence systems will be described; methods, systems, and articles of manufacture consistent with the presence systems may include additional or different components. For example, a processor may be implemented as a microprocessor, microcontroller, application specific integrated circuit (ASIC), discrete logic, or a combination of other types of circuits or logic. Similarly, memories may be DRAM, SRAM, Flash or any other type of memory. Flags, parameters, lists, data, databases, tables, and other data structures may be separately stored and managed, may be incorporated into a single memory or database, may be distributed, or may be logically and physically organized in many different ways. The programs discussed below may be parts of a single program, separate programs, or distributed across multiple memories and/or processors.

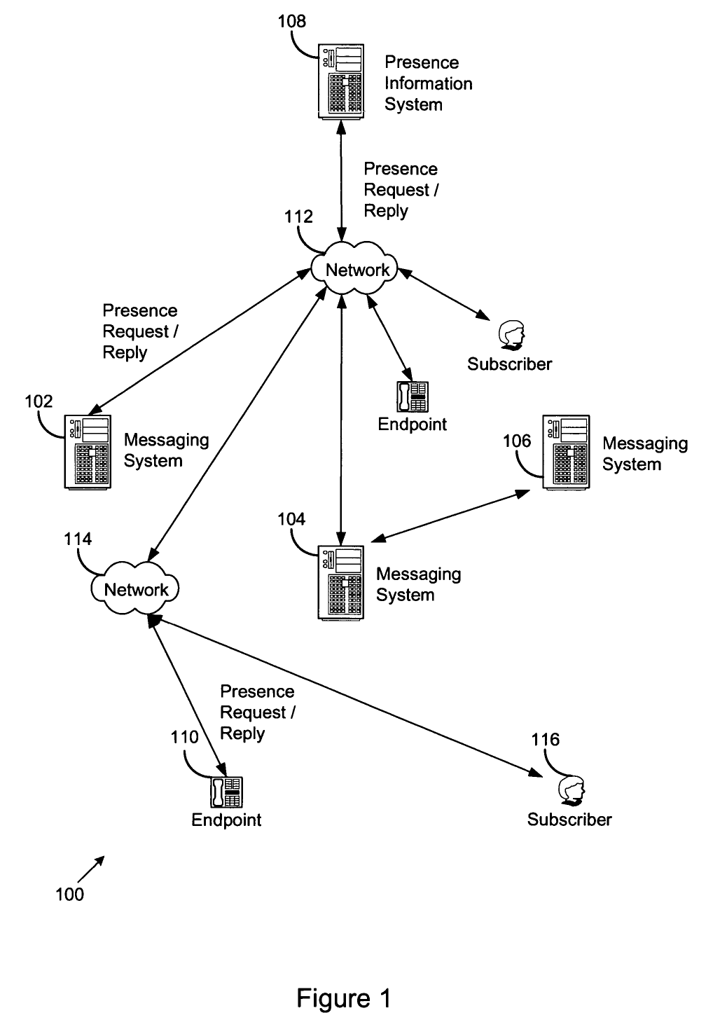

FIG. 1 shows a presence system network 100. The entities interacting in the network 100 may include messaging systems 102, 104, and 106, a presence information system 108, endpoints 110, and/or other entities. The messaging systems 102-106 may subscribe to the presence information system 108 to obtain presence information on behalf of a subscriber. As will be described in more detail below, the presence information system 108 may allow or block access to the presence information in a contact group-driven manner. The messaging systems 102-106 may be multimedia messaging systems, or may selectively process specific types of messages such as voice messages, fax messages, instant messages, or other messages. The messaging system 102-106 may, for example, represent home or business computers that execute messaging programs such as instant messaging programs, email programs, video conferencing programs, or other messaging programs. Presence information for a subscriber 116 may be communicated between the endpoints 110, the presence information system 108 and/or the messaging systems 102-106.

The entities may communicate over one or more networks 112, 114 or interconnection of networks. The entities 102-110 and networks 112, 114 may exchange information using a packet based protocol. For example, the messaging systems 102-106, presence information system 108, and endpoints 110 may employ the Real Time Protocol (RTP) over the User Datagram Protocol (UDP). Other protocols, including the Transmission Control Protocol/Internet Protocol (TCP/IP) or other network protocols may be additionally or alternatively employed. In addition, the signaling between the entities 102-110 may proceed according to the H.323 packet-based multimedia communications system standard published by the International Telecommunications Union (ITU). The network or interconnection of networks 112, 114 may include the Public Switched Telephone Network (PSTN) and may deliver data to home or business computers, programs, PDAs, pagers, cell phones, wireline phones, internet phones, or any other communication device, electronic system, or system component or program.

The entities in the network 100 may employ protocols that adhere to any desired specification. For example, the entities may employ the Session Initiation Protocol (SIP) developed for Internet conferencing, telephony, presence, events notification and instant messaging, the Jabber protocol, or SIP for Instant Messaging and Presence Leveraging Extensions (SIMPLE). The form and content of the presence information may be established according to protocols consistent with the Internet Engineering Task Force (IETF) Request for Comments (RFC) 2778 or IETF RFC 2779. Alternatively, the entities may employ extensions to RFC 2778 or RFC 2779, or may employ proprietary protocols.

The subscribers 116 interact with the network 100. A subscriber may be any entity that may be associated with presence information, including a human being, an electronic device, a computer program, or other entity. The subscriber 116 may have one or more presence states that may be relative to one or more endpoints 110. Table 1 shows examples of presence states and descriptions of the presence states.

TABLE 1

| Presence State | Description |
|---|---|
| ‘Available’ | The subscriber is in the office and available to |
| | receive messages. |
| ‘On the Phone’ | The subscriber is in the office, but is on the |
| | phone. |
| ‘In Office’ | The subscriber is in the office. |
| ‘Be Right Back’ | The subscriber is in the office but is not |
| | available. |
| ‘In Meeting’ | The subscriber is in the office but is not |
| | available because they are in a meeting. |
| ‘On Business Trip’ | The subscriber is not in the office and is not |
| | available to receive messages. |
| ‘Out of Office’ | The subscriber is not in the office and is not |
| | available to receive messages. |
| ‘On Vacation’ | The subscriber is not available to receive |
| | messages. |
| ‘No Interruptions’ | The subscriber is in the office but is not |
| | available to receive messages. |
| ‘Working | The subscriber is working and available, but |
| Remotely’ | not in the office. |
| ‘Unknown’ | It is not known whether the subscriber is |
| | available. |

The presence states shown in Table 1 may be applicable to an individual subscriber 116. The presence states may also be applicable to other entities, including aggregate entities such as workgroups, group mailboxes or group phone connections. For example, a presence state may reflect the availability of a group of customer service representatives in a complaint department. When no representative is available to handle the call, the associated presence state may be ‘On the Phone’. The presence information may reflect the availability of at least one member of the group, or may reflect other presence information applicable to the group as a whole.

For example, the ‘Be Right Back’ presence state indicates that the subscriber is in the office or otherwise available. However, the subscriber is temporarily away from the endpoint at which the subscriber receives messages. Different, fewer, or additional presence states may be used. As another example, the collection of presence states may simply be ‘Idle’, ‘Busy’, and ‘Away’.

Presence states may also reflect an aggregated media state. The aggregated media states may apply to specific typos of communication or may apply over any other subset of endpoints associated with the subscriber. As examples, the aggregated media states may apply to voice communications, instant messaging, and email messaging. Accordingly, a subscriber that is associated with multiple endpoints (e.g., phone numbers, email addresses, or instant messaging addresses) may have a presence state that aggregates availability over any subset of the endpoints. For example, a subscriber with a desk phone and a cell phone may have an aggregated media presence state of ‘Busy’ when at least one of the phones is in use. As another example, the subscriber may have an aggregated media presence state of ‘Available’ when both phones are not in use. Table 2 shows examples of aggregated media states. Different, fewer, or additional aggregated presence states may be used.

TABLE 2

| Presence State | Note |
|---|---|
| ‘Busy’ | The subscriber is in the office but is currently busy. |
| ‘Online’ | The subscriber is in the office and is connected to an |
| | instant messaging service. |
| ‘Offline’ | The subscriber is disconnected from their instant |
| | messaging service. |
| ‘Unknown’ | The actual state fo the subscriber is currently unknown. |
| ‘Available’ | The subscriber is in the office, and is not on the phone, |
| | interacting with instant messaging, or interacting with |
| | an email system. |

The endpoints 110 and/or subscribers 116 may communicate presence information to the presence information system 108. For example, the endpoints 110 may monitor subscriber activity and communicate a presence message to the presence information system 108. The presence message may indicate, as examples, that the subscriber has initiated a phone call, ended a phone call, started to type an instant message or email message, or may indicate any other presence information.

The presence state information may be communicated in the form of a presence document. The format of the presence document may adhere to any proposed or accepted standard for communicating presence information. In one implementation, the presence document is an extensible markup language (XML) document that identifies a subscriber and the presence or availability of the subscriber with respect to one or more ‘addresses’, including endpoints such as telephone numbers, email addresses, instant messaging addresses, or the like. When an endpoint publishes a presence document to the presence information system 108, the presence document typically only contains information about that particular endpoint. The presence information system 108 may then aggregate information from all of the subscriber's endpoints. The aggregate presence document may be made available in whole or in part to other endpoints that request the presence information.

The presence information system 108 receives the presence document. The systems 102-108 may process the presence documents and may maintain presence information for one or more subscribers. Alternatively or additionally, the messaging systems 102-106 may receive presence documents from the presence information system 108.

For example, the messaging system 102 may at any time poll or subscribe to the presence information system 108 for the current presence state of a subscriber. In response, the presence information system 108 may communicate a presence document for the subscriber to the messaging system 102. In such a case, the messaging system 102 acts as another endpoint with regard to receipt of presence information. The presence information system 108 need not send the presence document or populate the presence document with the requested information in every instance, however. Instead, the presence information system 108 may manage the availability of the subscriber presence state.

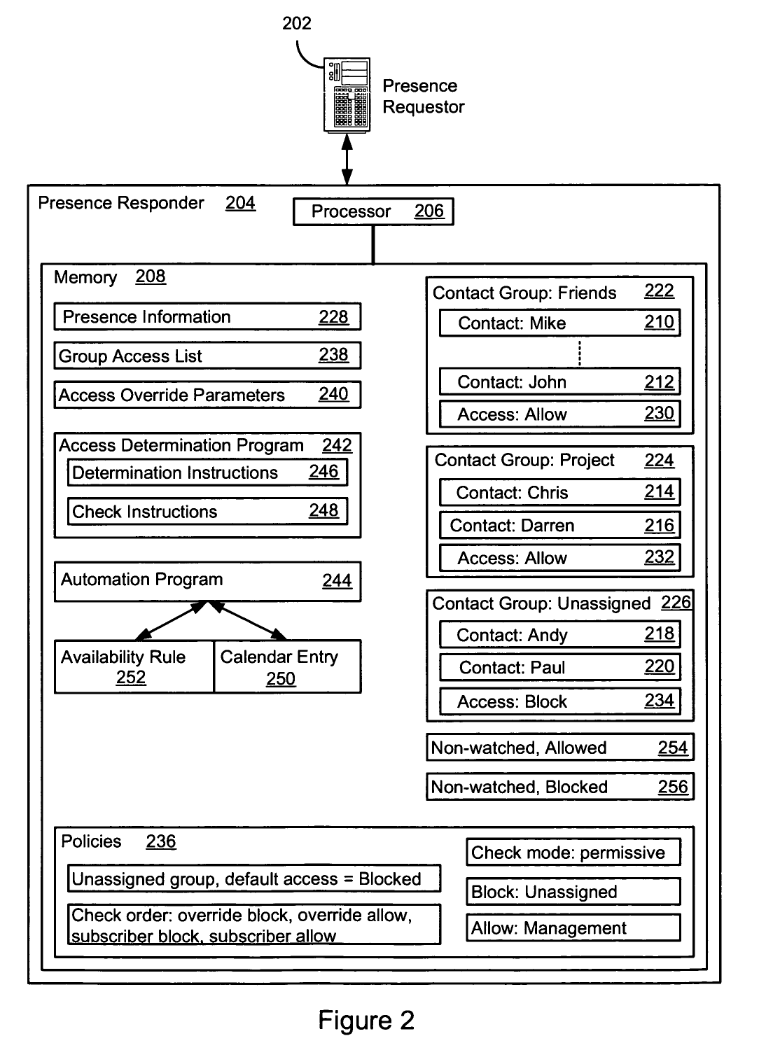

In FIG. 2, a presence requestor 202 requests presence information for a subscriber from the presence responder 204. The presence requester and presence responder may be any of the entities interacting in the network 100. The presence responder 204 is described in more detail below.

The presence responder 204 includes a processor 206 and a memory 208. The memory 208 includes contacts 210, 212, 214, 216, 218, and 220 organized into groups 222, 224, and 226. A contact may be any entity that the underlying infrastructure allows the subscriber to define and associate with a group. A contact may be another subscriber, a group, a program, a document, automated programs (e.g., bots), or another entity. The contacts generally represent entities interested in the subscriber's presence. In some cases, a contact group may include only contacts whose presence is also of interest to the subscriber (e.g., contacts in the subscriber's buddy lists). In other cases, the contact groups may include only contacts whose presence is not of interest to the subscriber.

In the example shown in FIG. 2, the subscriber has defined contacts 210 and 212 for Mike and John and assigned those contacts to the Friends group 222. Similarly, the subscriber has defined contacts 214 and 216 for Chris and Darren and assigned those contacts to the Project group 224. The subscriber has not explicitly assigned contacts 218 and 220 for Andy and Paul to any group. However, the responder 204 may transparently assign such contacts to a default group, such as the Unassigned group 226 shown in FIG. 2.

Additional contact groups may also be defined in the memory 208. FIG. 2 shows a non-watched allowed contact group 254 and a non-watched blocked contact group 256. One distinction between the non-watched groups 254 and 256 and the contact groups 222-226 is that the non-watched groups include contacts for entities watching the subscriber, but whom the subscriber is not watching.

Furthermore, an administrator or other authorized entity may create additional contact groups in the presence system. For example, the presence system may create and populate a Management contact group. The additional contact groups may be visible or hidden from the subscriber, and may be editable or protected from editing by the subscriber.

Group access parameters guide the presence responder 204 with regard to contacts that are allowed access to subscriber presence information 228. Two examples are shown in FIG. 2. In the first example, each contact group includes an access field that the subscriber may set to indicate whether contacts in the group as a whole are allowed access to subscriber presence information.

The access field to 230 is associated with the Friends group 222 and is set to allow access to subscriber presence information for the in the Friends group 222. The access field 232 is associated with the Project group 224 and is set to allow access to subscriber presence information for contacts in the Project group 224. The access field 234 is associated with the Unassigned group 226. The Unassigned group access field 234 or any other access field may be set by the presence system to a default value according to a predefined policy 236 established in the presence responder 204. In the example shown in FIG. 2, the Unassigned group access field has been set to block access for those contacts in the Unassigned group 226.

In the second example, the presence responder 204 maintains a group access/block list 238. The group access list 238 may be implemented as a list of groups containing contacts that are allowed access to the subscriber presence information. The group access list may additionally or alternatively include a list of groups containing contacts that are blocked from access to the subscriber presence information.

The presence responder 204 may also include access override parameters 240. The override parameters 240 may allow access or block access to presence information regardless of the group access parameter settings established by the subscriber. System policies 236 may establish the override parameters 240.

The memory 208 also includes an access determination program 242 and an automation program 244 As will be explained in more detail below, the access determination program 242 may include determination instructions 246 and check instructions 248. The determination instructions 246 may search the groups to ascertain to which contact groups a presence requester belongs. The check instructions 248 examine the access parameters to ascertain whether the presence requester is allowed access to subscriber presence information.

As will also be described in more detail below, the automation program 244 may automatically change group access parameters. For example the automation program 244 may process calendar entries 250 or availability rules 252 stored in the memory 208. When an availability rule 252 is applicable, or in response to a calendar entry 250, the automation program 244 may allow or block access to subscriber presence information.

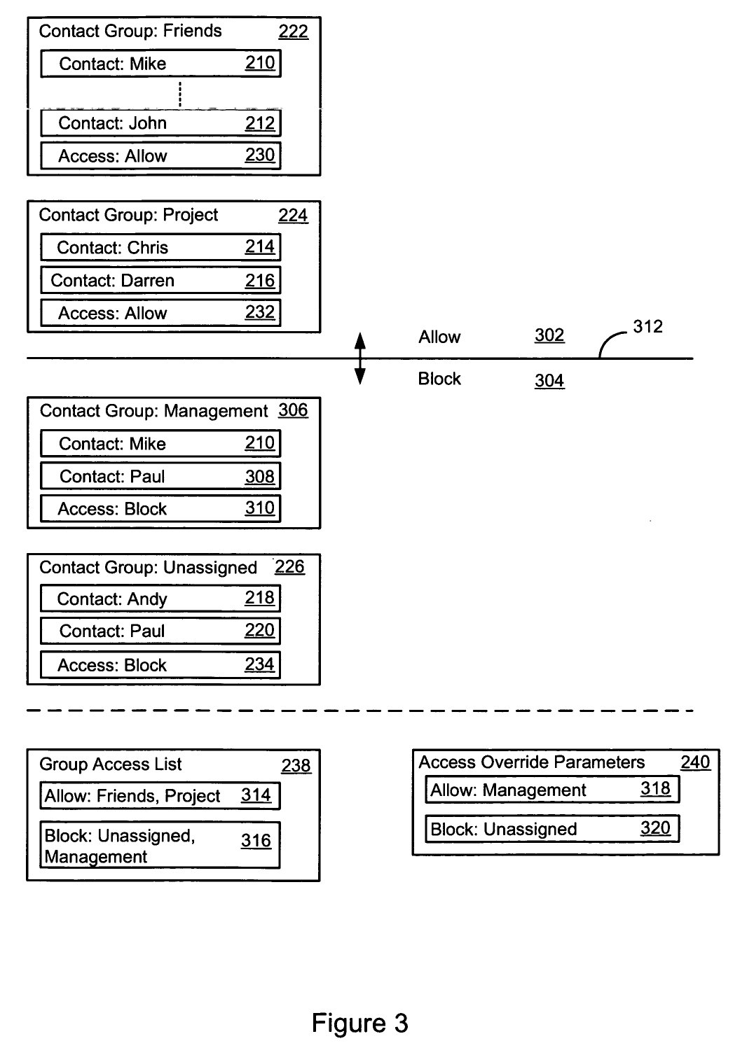

FIG. 3 illustrates a division of groups into an Allowed category 302 and a Blocked category 304. FIG. 3 also shown an additional contact group 306 for management individuals. The contact 210 for Mike is associated with both the Management contact group 306 and the Friends contact group 222. The Management contact group also includes a contact 308 for Paul. The subscriber has set the access control field 310 to Block.

From the subscriber's perspective, the Allow/Block line 312 divides the contact groups 222, 224, 226, and 306 between Blocked and Allowed. The contact groups 222 and 224 above the line are allowed access to the subscriber presence information. The contact groups 226 and 306 below the line are blocked from access to the subscriber presence information. The presence system may implement a user interface that allows the subscriber to graphically move contact groups above or below the Allow/Block line 312 and automatically update the group access parameters.

In FIG. 3, the group access list 238 includes a group Allow list 314 and a group Block list 316. Consistent with the access fields 230, 232, 234, and 310, the group Allow list 314 includes entries for the Friends contact group 222 and the Project contact group 224. The group Block list 316 includes entries for the Unassigned contact list 226 and the Management contact group 306.

Also shown in FIG. 3 are the access override parameters 240. Set by the administrator or by system policies 236, the override parameters 240 include an override Allow list 318 and an override Block list 320. Depending on the implementation, it may be mandatory that the responder 204 allow contacts in the groups in the override Allow list 318 access to subscriber presence information. Similarly, it may be mandatory that the responder 204 block contacts in the groups in the override Block list 320 from subscriber presence information.

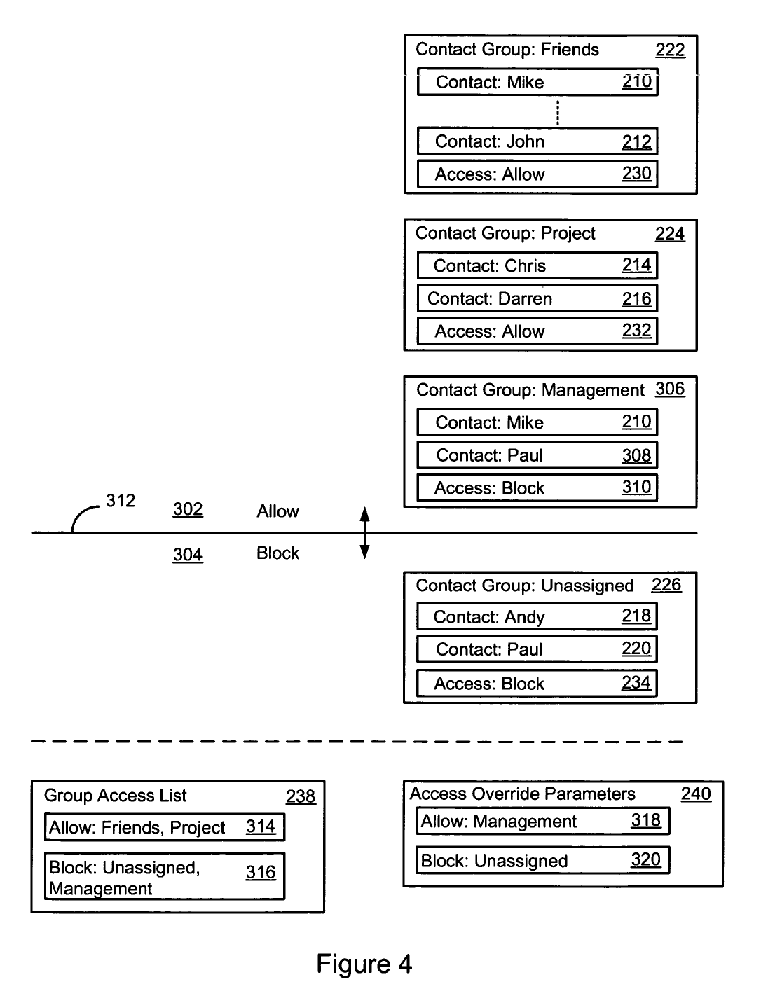

While the subscriber has set the access field 310 and/or the group Block list 316 to Block management contacts from obtaining presence information, the access override parameters 240 may apply regardless of the access field 310 or group Block list 316. Thus, in FIG. 4, the contact groups 222, 224, 226, and 306 are shown arranged above and below the Allow/Block line 312 after consideration of the access override parameters 240. In the example shown in FIG. 4, the management contact group is allowed access to subscriber presence information regardless of the fact that the subscriber has set the access field 310 and/or group block list 316 to Block the Management contact group.

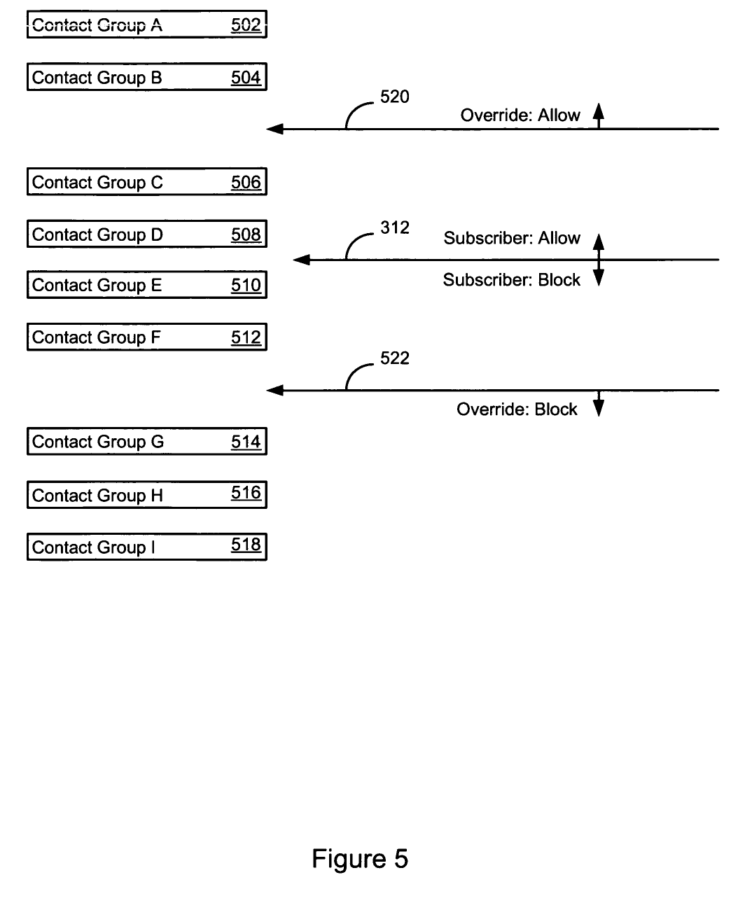

FIG. 5 shows how contact groups are arranged with regard to both group override access parameters and subscriber adjustable access parameters. Based on the mandatory allow line 520, certain contact groups (e.g., the contacts groups 502 and 504) are always allowed access to the subscriber presence information. Based on the mandatory block line 522, certain contact groups (e.g., the contact groups 514, 516, and 518) are always blocked from access to the subscriber presence information. The subscriber may block or allow access to his presence information from contacts in the contact groups 506, 508, 510, and 512 as shown by the subscriber allow/block line 312.

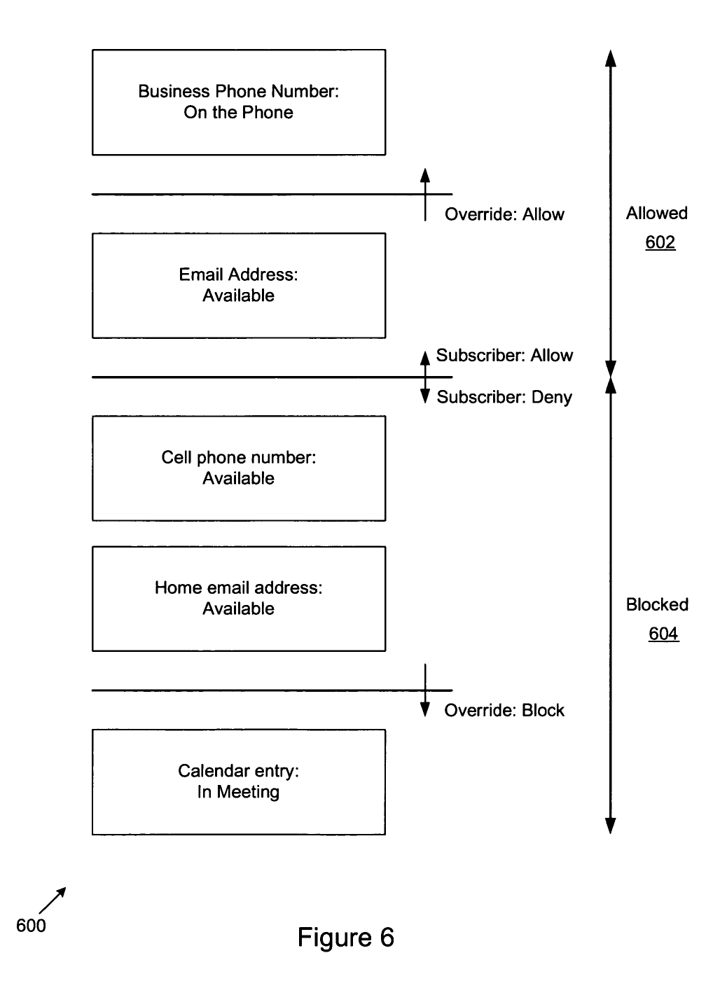

As shown in FIG. 6, presence information 600 itself may be divided between an allowed a portion 602 and a blocked portion 604. The allowed portions and/or blocked portions may be set on a per-contact or per-group basis, and may include the presence information itself, the endpoint information (e.g., phone number or email address), or other data relating to the subscriber's presence. Presence information access parameters may control the portions of the presence information 600 are ‘allowed portions’ and which are ‘blocked portions’. The presence information access parameters may be subscriber adjustable parameters like the group access parameters discussed above. Furthermore, the responder 204 may implement mandatory allowed portions of the subscriber presence information and/or mandatory blocked portions of the subscriber presence information using override access parameters.

In the example shown in FIG. 6, the system policies 236 block access to presence information relating to the subscriber's calendar entries and allow access to presence information relating to the subscriber's business phone number. The subscriber may set the presence information access parameters to allow access or deny access to, as examples, portions of the presence information associated with the subscriber's e-mail address, cell phone number, and home e-mail address.

Alternative or additionally, allow/block access may be based on any given portion of presence information. Conceptually, one or more subscriber and/or administrative Allow/Block lines specific to a given type of presence information may be placed across the contact groups. Accordingly, the access control illustrated in FIG. 5 is extensible to portions of presence information and is not limited to the complete bundle of all available presence information.

On an individual basis, contact groups may then be allowed or blocked from access to portions of the presence information depending on the override and subscriber allow/block parameter settings. For example, subscriber availability presence information may be made available to selected groups, while the subscriber's email presence information may be blocked from selected groups, including those allowed access to the availability presence information. In other words, each group may be allowed access to some presence information or may be blocked from access to some presence information for any given subscriber.

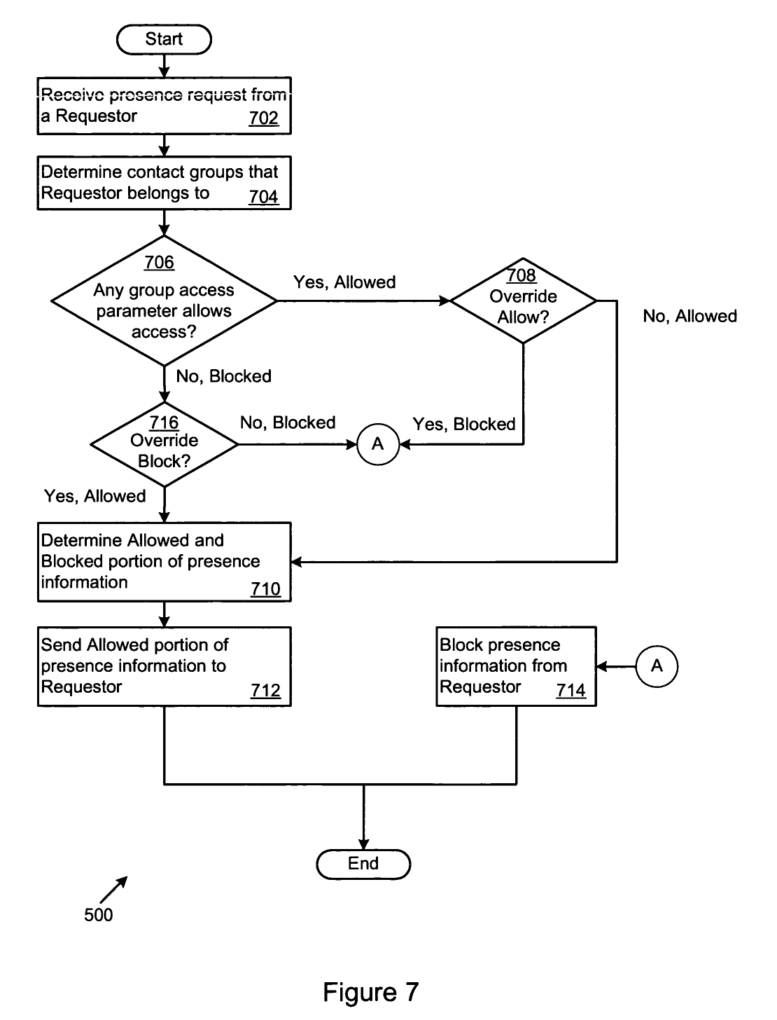

It was noted above that the access determination program 242 processed presence information requests. FIG. 7 shows the acts that may be taken by the access determination program 242. The program 242 receives the presence information request from the requester 202 (Act 702) and determines to which of the contact groups the requester 202 belongs (Act 704), for example, by searching for matching contacts in the contact groups.

If the subscriber has allowed access to presence information for any group to which the requester is assigned (Act 706), the program 242 may then determine whether an access override parameter blocks access for that group (Act 708). If access is allowed, the program 242 may then determine an allowed portion or blocked portion of presence information available to the requester 202 (Act 710). The program 242 then sends the allowed portion of the presence information to the requester 202 (Act 712).

On the other hand if the subscriber has allowed access to the presence information but the access override parameters block access to the presence information, then that the program 242 may block the requester 202 (Act 714). To that end, the program 242 may respond with a ‘blocked’ response to the requester 202, may make no response to the requester 202 or may otherwise withhold the presence information.

The group access parameters may block access to the presence information (Act 706), but the override access parameters may allow access (Act 716). In this case, the program 242 may also determine an allowed portion or blocked portion of presence information (Act 710) and send the allowed portion to the requester 202 (Act 712). However, if the block is not overridden, the program 242 blocks the requester 202 (Act 714).

The program 242 and system policies 236 may establish any particular priority order for the access parameters. In one implementation, the program 242 checks first for override Blocks, then override Allows, then subscriber Blocks, then subscriber Allows. In other implementations, the program 242 may give priority to override Allows before override Blocks. Other priority orders are also possible.

System policies 236 may modify the acts taken by the access determination program 242. In one embodiment, the system policies 236 may distinguish between a restrictive mode and a permissive mode of access to presence information. For example, when the subscriber sets his mode to be restrictive, the program 242 may block access if any group that the requester belongs to has his access blocked instead of allowing access when any group that the requester belongs to has access allowed.

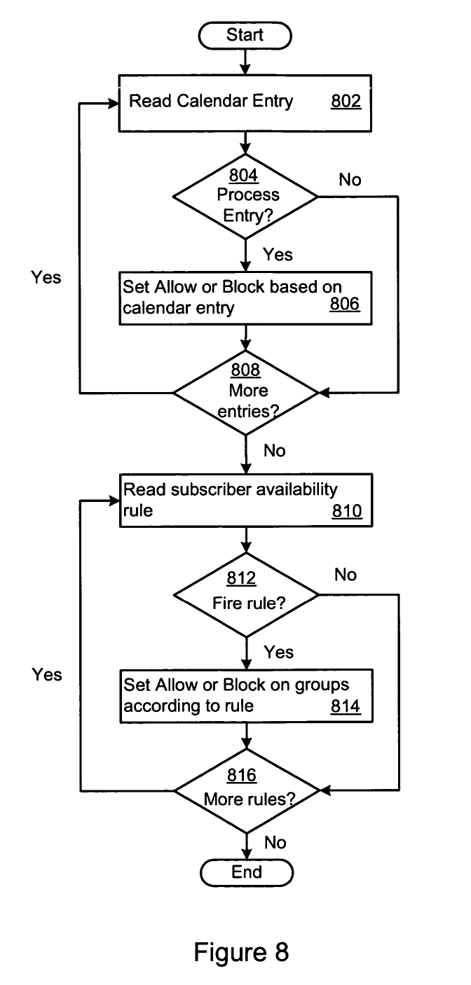

FIG. 8 shows one example of the acts may be taken by the automation program 244. The automation program 244 may read a calendar entry 250 (Act 802). When the calendar entry is one that the automation program 244 recognizes (Act 804), the automation program 244 may responsively change a group access parameter.

For example, when the calendar entry is ‘In Meeting’, the automation program 244 may set one or more of the group access parameters to block access to or allow access to the subscriber presence information for one or more groups specified in the calendar entry, by the system policies 236, or specified in other manners. The automation program 244 may change the access parameters for the duration of calendar entry (e.g., for the 2 hours the subscriber is in the meeting). After the event represented by the calendar entry, the automation program 244 may automatically change the access parameters back to their pre-event state. The automation program 244 may process any number of calendar entries in this manner (Act 808).

The automation program 244 may also process subscriber rules 252. In doing so, the automation program 244 reads the presence availability rules 252 (Act 810) on a periodic, scheduled, commanded, or other basis. If the rule fires (Act 812), then in the automation program 244 a set one or more of the group access parameters to block access to or allow access to the subscriber presence information (Act 814). For example, the subscriber may define the following rule: ‘If I am editing Critical_code.doc, then block my presence information.’ The automation program 244 may process any number of rules (Act 816).

The presence management system described above may be implemented as a presence management layer to an underlying native presence infrastructure. The native presence infrastructure may be the Microsoft Presence Agent Server (PAS). The presence management layer may be implemented on top of the native presence infrastructure even if the native infrastructure is not open to modification or replacement. In such cases, allow/block decisions are available to subscribers that employ the presence management system interface for presence information.

For example, the Microsoft PAS may maintain the contacts, the contact group definitions, and the subscriber Allow/Block list on the basis of individual contacts. The presence management layer may then overlay the Microsoft PAS. To that end, the presence management layer may maintain in a database contact groups parallel to that established in Microsoft PAS as well as additional information such as group access lists 238, override access parameters 240, rules 252, and any other data.

When a new contact group is created in Windows Messenger or the Live Communications Client, the presence management layer may create an entry for this group and place this group below the subscriber's Allow/Block line. Similarly, when a contact group is deleted in Windows Messenger, the presence management layer will delete the corresponding contact group entry. When a contact is added to or deleted from a contact group in Windows Messenger, the presence management layer will add or delete the contact to or from the corresponding parallel contact group maintained by the presence management layer. A new contact, unassigned to any group in Windows Messenger, may be assigned to the Unassigned Contact Group 226 in the presence management layer.

Changes made in Windows Messenger to Allow/Block settings for individual contacts may be checked against the parallel groups maintained in by the presence management layer. The presence management layer updates the parallel groups to be consistent with the changes made to the individual contacts. The subscriber may change the Allow/Block setting for the parallel groups. The presence management layer may then update the Windows Messenger Allow/Block lists to be consistent with the subscriber's changes.

The subscriber may add a contact using the presence management layer. The presence management layer may then add the contact to the Windows Messenger/Live Communications Client underlying roaming contact group and add the contact to the underlying roaming Allow/Block list. When a contact is deleted using the presence management layer, the presence management layer may remove contact to the Windows Messenger/Live Communications Client underlying roaming contact group and remove the contact from the underlying roaming Allow/Block list. Similarly, when a new user contact group is added or deleted using the presence management layer, the contact group will also be added to (or deleted from) the underlying set of Windows Messenger/Live Communications Client contact groups. Furthermore, subscriber changes to the Allow/Block line are reproduced in the underlying Allow/Block list on a contact-by-contact basis.

Performing presence information availability at a group level may reduce the time and mistakes made managing contacts on an individual basis. The management is less cumbersome and also allows for automated adjustment to the availability of presence information. Furthermore administrator or other authorized entity may overlay mandatory presence availability policies on top of those set by the subscriber to ensure that critical groups have access to the presence information they need, or that unnecessary groups do not have access.

It is therefore intended that the foregoing detailed description be regarded as illustrative rather than limiting, and that it be understood that it is the following claims, including all equivalents, that are intended to define the spirit and scope of this invention.

1. A method for determining the availability of presence information to a:
requestor of the presence information, the method comprising:
determining a contact group assigned to a presence requestor; and
checking a group access parameter associated with the contact group to determine whether contact group members are allowed access or are denied access to requested presence information.

2. The method of claim 1, further comprising:
when the contact group members are allowed access, determining an allowed portion of the requested presence information to deliver to the requestor.

3. The method of claim 1, further comprising:
assigning an unassigned contact into a default group.

4. The method of claim 3, further comprising:
setting a default access parameter associated with the default group to ‘Allow’ or ‘Block’ based on a predefined system policy.

5. The method of claim 1, further comprising:
checking an access override parameter associated with the contact group to determine whether to disregard the group access parameter in favor of the access override parameter.

6. The method of claim 5, where the access override parameter is an ‘Allow Access’ parameter.

7. The method of claim 5, where the access override parameter is a ‘Block Access' parameter.

8. The method of claim 1, where the requested presence information is associated with a presence system subscriber, and further comprising:
evaluating an availability rule defined by the presence system subscriber; and
automatically setting the group access parameter based on the availability rule.

9. The method of claim 1, where the requested presence information is associated with a presence system subscriber, and further comprising:
reading a calendar entry associated with the presence system subscriber; and
automatically setting the group access parameter based on the calendar entry.

10. A presence system comprising:
a memory comprising:
a contact for a presence requester associated with a contact group;
a group access parameter associated with the contact group; and
an access determination program that checks the group access parameter to determine whether the group members are allowed access to the requested presence information; and
a processor coupled to the memory that executes the access determination program.

11. The presence system of claim 10, where the group access parameter comprises a group access list, a group block list, or both.

12. The presence system of claim 10, where the group access parameter comprises an access field set for the contact group.

13. The presence system of claim 10, where the memory further comprises an access override parameter associated with the contact group.

14. The presence system of claim 13, where the access override parameter comprises an ‘Allow Access’ parameter or a Block Access’ parameter.

15. The presence system of claim 14, where the access determination program overrides the group access parameter based on the access override parameter.

16. The presence system of claim 14, where the memory further comprises an automation program that evaluates an availability rule defined by a presence system subscriber and automatically sets the group access parameter based the availability rule.

17. The method of claim 14, where the memory further comprises an automation program that reads a calendar entry associated with the presence system subscriber and automatically sets the group access parameter based on the calendar entry.

18. A machine readable medium comprising machine executable instructions, including:
determination instructions that determine a contact group assigned to a presence requester; and
check instructions that determine whether contact group members are allowed access or are denied access to requested presence information, based on a group access parameter associated with the contact group.

19. The machine readable medium of claim 18, where the group access parameter comprises a group access list, a group block list, or both.

20. The machine readable medium of claim 18, where the group access parameter comprises an access field set for the contact group.

21. The machine readable medium of claim 18, further comprising:
override instructions that override the group access parameter based on an access override parameter associated with the contact group.

22. The machine readable medium of claim 21, where the access override parameter forces availability or blocking of the requested presence information for members of the contact group.

23. The machine readable medium of claim 18, further comprising:
assignment instructions that assign an ungrouped contact into a default group and that set a default access parameter associated with the default group.

24. The machine readable medium of claim 18, further comprising:
evaluation instructions that evaluate an availability rule defined by a presence system subscriber; and
access setting instructions that automatically set the group access parameter based on the availability rule.

25. The machine readable medium of claim 18, further comprising:
calendar access instructions that read a calendar entry associated with a presence system subscriber; and
access setting instructions that automatically set the group access parameter based on the calendar entry.

26. A presence system that manages availability of presence information for a subscriber, the presence system comprising:
a memory comprising:
multiple subscriber defined contact groups;
multiple contacts, each contact organized into at least one of the subscriber defined contact groups or a system created default group;
a group access parameter associated with each subscriber defined contact group;
an access override parameter associated with at least one of the subscriber defined contact groups;
an access determination program that checks the group access parameters to determine whether group members are allowed access to requested presence information for the subscriber; and
an override determination program that checks the access override parameter to determine whether to allow or block access to the presence information regardless of the group access parameters; and
a processor coupled to the memory that executes the access determination program and the override determination program.

27. The presence system of claim 26, where the memory further comprises:
an automation program that evaluates an availability rule defined by the subscriber and automatically sets the group access parameter based the availability rule.

28. The presence system of claim 26, where the memory further comprises:
an automation program that reads a calendar entry associated with the subscriber and automatically sets the group access parameter based on the calendar entry.

29. The presence system of claim 26, where the access override parameter forces availability or blocking of presence information for each contact in at least one of the multiple subscriber defined contact groups.

30. The presence system of claim 26, further comprising:
a presence selection parameter that divides the presence information into an allowed portion to deliver to the requester, and a blocked portion to withhold from the requestor.
